(19) United States
(12) Patent Application Publication
(10) Pub. No.: US 2006/0222449 A1
(43) Pub. Date: Oct. 5, 2006

(54) Writing implement with detachable stylus

(76) Inventor: Carl Cetera, Tenafly, NJ (US)

Correspondence Address: THE SONI LAW FIRM, 55 S. LAKE AVE SUITE 720, PASADENA, CA, 91101, US

(21) Appl. No.: 11/096,982

(22) Filed: Mar. 31, 2005

(51) Int. Cl. B43K 29/00; B43K 1/10

(52) U.S. Cl. 401/258; 401/195; 401/37; 401/131

(57) ABSTRACT

A multifunction handheld writing instrument includes a combination device of a pocket clip and a removable stylus. The pocket clip has a first part that attaches to an elongated handheld instrument, and a elongated second part which includes a distal stylus tip. The proximal end of the second part of the clip engages an attachment means on the body. When the clip is in a first position, it is biased against the writing instrument body and may be used for attachment to, for example, a shirt pocket. The clip may be completely detached from the first part and used separately as a stylus, or in a second position, whereby the elongated second part projects axially outward and may be used as a stylus. An advantage of the clip it allows the user to readily switch back and forth between writing with a ball point pen tip and writing with the stylus.

### BACKGROUND OF THE INVENTION

The present invention relates to a multifunction handheld writing instrument. More specifically, the present invention relates to a handheld writing instrument that includes a combination device of pocket clip, and stylus for use, for example, as an input device for a personal data assistant.

A variety of combination writing instruments are well known in the prior art. U.S. Pat. No. 4,129,925 to Brown describes a combined nail file and writing instrument clip attachment. U.S. Pat. No. 5,090,427 to Sherts discloses a combination finger groomer attachment that performs a variety of manicure operations, and writing instrument clip on a pen cap.

U.S. Pat. No. 6,076,986 to Manno, a continuation in part of U.S. Pat. No. 5,865,552 to Manno, discloses an assembly of a writing instrument and a tooth pick. The pick is pivotably attached by a hinge to the writing instrument clip. The hinge enables the pick to move between a first position where the pick is disposed in a slot in the spring clip and a second position where the pick extends outward from the slot. The pick comprises a generally conically shaped body made of a polymeric material that is unlikely to injure the gums of a user and terminates in a point.

Writing instruments incorporating both a stylus tip and a ball point pen have also been described. Hazzard, in U.S. Pat. Nos. 5,913,629; 6,050,735; D402,690; and D424,112 disclose writing instruments with a ball point pen tip capable of projecting out from under a fixed stylus tip when the ball point mechanism is actuated. Hazzard does not describe a stylus tip is not part of a clip assembly.

A combination of a stylus tip and a pocket clip mounted on the cap of a writing instrument is described by Haffner in U.S. Pat. No. 6,659,673. In that invention, there is a slidable member functioning as a pocket clip on one end and as a stylus on the other end. The disadvantage of this device is that the end of the writing instrument closest to the clip attachment must be tapered in order to allow the stylus to extend out past the pen body. Furthermore, as the combination stylus and clip is mounted on a pen cap, the cap must be removed to get access to the ball point pen tip. In addition, the cap can be lost or misplaced. Finally, the pocket clip end is pointed, narrow, and fragile.

What is lacking in the existing art is a combination stylus and pocket clip which may be used on any elongated instrument. Such a combination would allow the user to readily switch back and forth from writing with a ball point tip to using the stylus without the necessity of actuating the ball point pen writing mechanism nor removing a pen cap.

### SUMMARY OF THE INVENTION

An object of the present invention to provide a combination device comprising a clip and a “PDA” type stylus, wherein said device may be used with an elongated writing instrument. The present invention will provide a combination device comprising a clip and a PDA stylus, wherein the stylus/clip is broad and sturdy and the PDA stylus is removable.

Still another object of this invention is to provide a combination device comprising a clip and a PDA stylus, wherein said PDA device could be placed on a part of a writing instrument other than the cap. Accordingly, the present invention provides a combination device comprising a clip and a PDA stylus, wherein said stylus can be easily deployed from the pen or securely stored within the clip.

The objects of this invention are accomplished by providing a multifunction handheld writing instrument includes a combination device of a pocket clip and a removable stylus. The pocket clip has a first part that attaches to an elongated handheld instrument, for example a writing instrument. The pocket clip further includes an elongated second part which includes a distal stylus tip. The proximal end of the second part of the clip slidingly engages a track in the first part of the clip. When the second part of the clip is engaged with the first part of the clip in a first position, the distal end of the elongated second part is biased against the writing instrument body and may be used for attachment of the writing instrument to, for example, a shirt pocket. When the second part of the clip is engaged with the first part of the clip in a second position, the distal end of the elongated second part projects out past the top of the writing instrument body and may be used as a stylus. Alternatively, the second part may be detached from the first part and used separately as a stylus, without the first part. An advantage of the clip is that it allows the user to readily switch back and forth between writing with a ball point pen tip and writing with the stylus.

### BRIEF DESCRIPTION OF THE DRAWINGS

These and other aspects of the invention will now be described with reference to the accompanying drawings, in which:

FIG. 1 is a perspective view of a preferred embodiment of the hand held implement depicting the clip mounted to the body at the second end of the body.

FIG. 2 is a front view of a preferred embodiment of the hand held implement and shows the clip mounted to the body at the second end of the body in the position wherein it is locked to the body by means of the rotatable locking device.

FIG. 3 is a side view of a preferred embodiment of the hand held implement and shows the clip locked to the body by means of the rotatable locking device and shows the clip locking tab.

FIG. 4 is a back view of a preferred embodiment of the hand held implement and shows the clip locked to the body by means of the rotatable locking device, with the flat of the locking device positioned away from the slide means of the clip and body.

FIG. 5 is a top view of a preferred embodiment of the hand held implement and shows the clip locked to the body by means of the rotatable locking device, with the flat of the locking device positioned 180° away from the slide means of the clip and body.

FIG. 6 is a perspective view of a preferred embodiment of the hand held implement depicting the clip slidably disengaged from and detached from the body.

FIG. 7 is a front view of a preferred embodiment of the hand held implement and shows the clip detached from the body in the position wherein it was slidably released from the body by means of the flat on the outer surface of the rotatable locking device.

### DETAILED DESCRIPTION OF THE INVENTION

The purpose of the hand held implement described by the present invention is to provide the user with a stylus tip which is detachable from the implement but that may also be reattached to the implement with the stylus point projection axially outward from the implement in a direction opposite the conventional tip end of the implement. When otherwise not in use, this stylus point would typically be attached to the body of the implement and biased against the body to function as a clip to attach the implement to another article, such as a shirt pocket. While the included drawings show and describe a writing implement, the contemplated scope of this invention is not so narrow. Examples of implements contemplated within the scope of the present invention may include writing implements such a pens and pencils, laser pointers, conventional pointers, cutting implements such as knives, awls and scribes, and other hand-held implements such as brushes, cosmetics applicators, soldering devices and computer styluses.

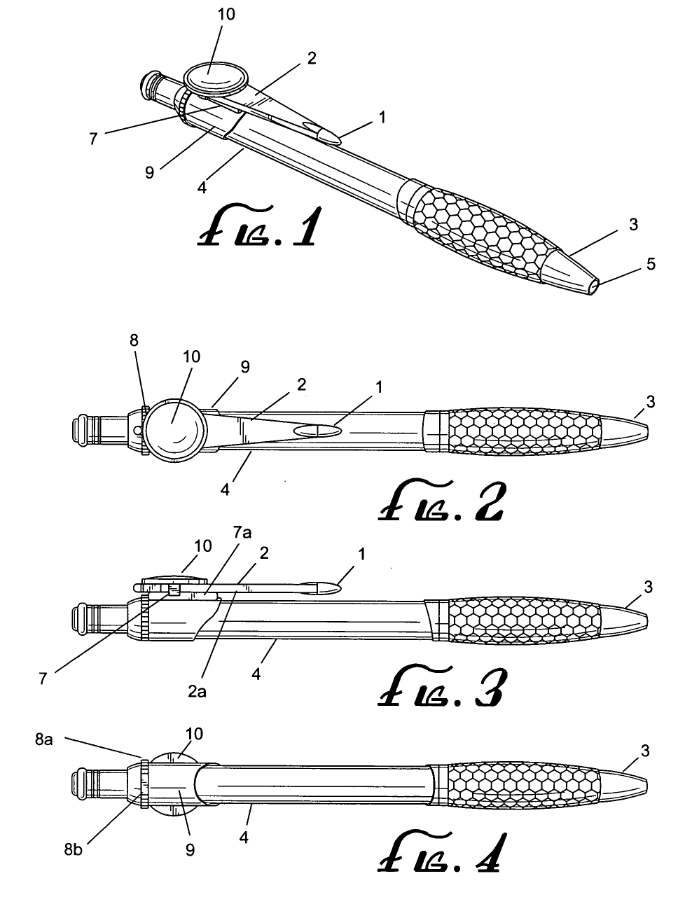

As presented in FIG. 1, in the preferred embodiment of the invention, the stylus point 1, is incorporated as one end of a removable clip 2. The implement itself comprises a first end 3, a second end 4, and the removable clip 2. In the embodiment of a writing implement, the first end 3 would further comprise an orifice 5, and a tip, which may extend from and retract into the orifice 5. As depicted in FIGS. 1 through 8, the first end 3, may optionally include a cushioned grip surface 6.

Referring to FIGS. 2, 3 and 7, in the preferred embodiment, the clip 2 is slidably engaged with and attached to second end 4 of the body. As depicted therein, a slide means 7, is utilized to permit the clip 2 to so function. This slide means 7 further comprises an axial dovetail way 7a, on the second end 4, which mates with a corresponding slide rail 7b, on the back side 2a, of the removable clip 2. In the preferred embodiment, to detach the clip 2 from the body, the clip 2 must traverse over a rotatable locking device 8. This device is a generally disc shaped component, which is dimensioned such that its major diameter 8a, extends radially outward beyond the point of the slide means 7.

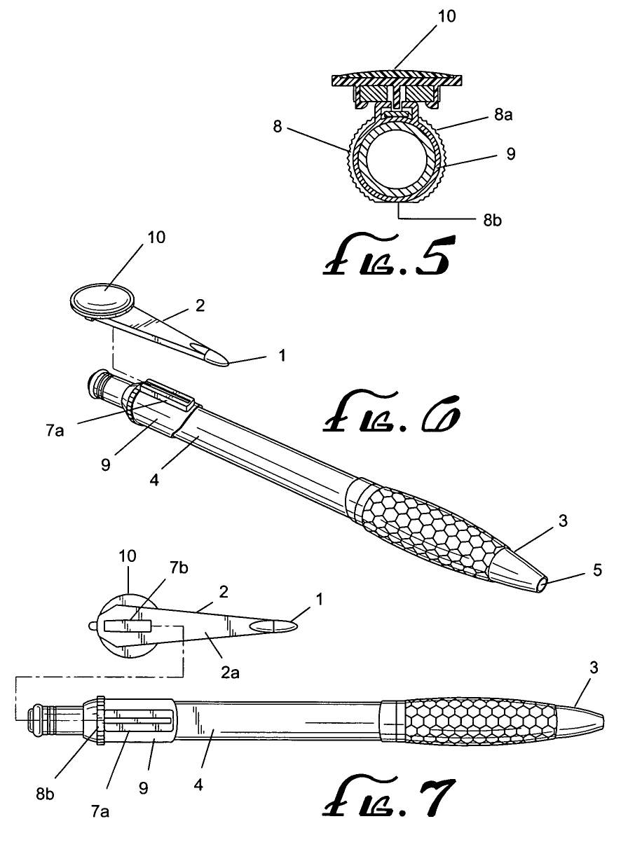

Referring to FIGS. 4, 6 and 8, the locking device 8, has at least one flat 8b, about its outer circumference, whereby rotation of the rotatable locking device 8 may present the flat 8b in a position where it is axially aligned with the slide means 7. In this axially aligned position, the slide rail 7b of the clip 2 may pass over the rotatable locking device 8, to permit the clip 2 to be detached from the body. As shown in FIG. 7, the dovetail way 7a, may be formed on a cap ring 9, however, the dovetail way 7a may alternatively be formed integrally with the second end 4.

As shown in FIG. 7, the preferred embodiment further includes a disc shaped member 10 which is separable from the removable clip 2. This member 10 may be then used for a variety of purposes, including, but not limited to, its use as a golf ball greens marker, or as a pin for a message board.

While the depicted embodiment shows the clip 2 removable by a slide means 7, the scope of the contemplated invention is not so limited. The invention includes a detachable clip for a hand held implement and any means for detachment and subsequent attachment would be within the scope of the invention. These alternate means for the detachment function may include, but would not be limited to, snap fitting the clip to the body, releasing pins to detach the clip, a rotatable release means, whereby the clip is rotated clockwise or counterclockwise with respect to the axis of the elongated body, spring loaded tabs which engage the second end and the clip, or any other means by which the clip may be readily attached to and detached from the body.

Finally, although the preferred embodiment depicts the implement as having a removable disc shaped member 10 for imprinted material, it is contemplated that any of the outer surfaces of the implement are well suited for and may be utilized for the imprinting of graphical or advertising material for the purposes of advertising or promotion.

What is claimed is:

1. A hand held implement comprising:
an elongated body and a removable clip;
said clip having a stylus tip on one end and an attachment means whereby the clip may be affixed to, or alternatively detached from, the body.

2. The hand held implement of claim 1 whereby the removable clip is of a size which may be used as a hand held stylus point tool independently from the hand held implement.

3. The hand held implement of claim 1, wherein the attachment means comprises a slide rail and slide way to slidably attach and detach the clip from the body.

4. The hand held implement of claim 1 selected from a group consisting of a pen, pencil, laser pointer, pointer, antenna, highlighter, or writing implement.

5. The hand held implement of claim 1 wherein the body further comprises a writing tip extending from an orifice in one end of the body.

6. The hand held implement of claim 1, further including printed or graphical imprinting on at least one surface for the purpose of advertising or promotion.

7. The hand held implement of claim 1 whereby the removable clip further includes a generally flat piece which is separable from the clip.

8. The hand held implement of claim 7 whereby the flat piece may be used as a golf ball marker.

9. A hand held implement comprising:
an elongated body having a first end, a second end and a removable stylus clip;
said first end further comprising a tip;
said second end further comprising a rotating locking device axially mounted at and generally perpendicular to the terminus of second end, to secure the clip to the body;
said removable stylus clip having a stylus point opposite an attachment end whereby the clip may be attached to the second end by a slide means;
said slide means comprising slide rails on the second end of the body to engage with a mating slide member on the attachment end of the clip;
said rotatable locking device comprising a disc shaped member having at least one flat on its outer diameter, whereby the locking device in use will preclude the clip from complete axial disengagement with the body, but a rotation of the locking device to axially align its flat with the slide means permits the clip to translate over the flat and thereby slideably detach from the body.

10. The hand held implement of claim 9, whereby the removable clip may be slidably attached to the body with the stylus end pointing toward the first end or alternatively pointing opposite the first end of the body.

11. The hand held implement of claim 9 whereby the removable clip is of a size which may be used as a hand held stylus point tool independently from the hand held implement.

12. The hand held implement of claim 9 selected from a group consisting of a pen, pencil, laser pointer, pointer, antenna, highlighter, or writing implement.

13. The hand held implement of claim 9 wherein the tip comprises a writing tip extending from an orifice in the first end.

14. The hand held implement of claim 9, wherein the first end further includes a cushioned grip surface.

15. The hand held implement of claim 9, further including printed or graphical imprinting on at least one surface for the purpose of advertising or promotion.

16. The hand held implement of claim 9 whereby the removable clip further includes a generally flat piece separable from the clip.

17. The hand held implement of claim 16 whereby the flat piece may be used as a golf ball marker.

18. The hand held implement of claim 16, further including printed or graphical imprinting on at least one surface for the purpose of advertising or promotion.

19. A method of advertising or promotion comprising the imprinting of printed or graphical material on a surface of a hand held implement having an elongated body having a first end, a second end and a removable stylus clip;
said first end further comprising a tip;
said second end further comprising a rotating locking device axially mounted at and generally perpendicular to the terminus of second end, to secure the clip to the body;
said removable stylus clip having a stylus point opposite an attachment end whereby the clip may be attached to the second end by a slide means;
said slide means comprising slide rails on the second end of the body to engage with a mating slide member on the attachment end of the clip;
said rotatable locking device comprising a disc shaped member having at least one flat on its outer diameter, whereby the locking device in use will preclude the clip from complete axial disengagement with the body, but a rotation of the locking device to axially align its flat with the slide means permits the clip to translate over the flat and thereby slideably detach from the body.

20. The method of claim 19, wherein the hand held implement is selected from a group consisting of a pen, pencil, laser pointer, pointer, antenna, highlighter, or writing implement.

21. The method of claim 19, wherein said first end includes a writing tip which may extend from an axial orifice in the first end.
